(19) United States
(12) Patent Application Publication
(10) Pub. No.: US 2024/0366017 A1
(43) Pub. Date: Nov. 7, 2024

(54) HORIZONTAL FOOD INGREDIENT DISPENSER FOR AUTOMATED COOKING APPARATUS

(71) Applicant: KITCHEN ROBOTICS LTD, Modiin (IL)

(72) Inventors: DAVID BEN-DAVID, Rehovot (IL); NIKOLAY SOLDATENKO, Kiryat-Ono (IL)

(73) Assignee: KITCHEN ROBOTICS LTD, Modiin (IL)

(21) Appl. No.: 18/141,522

(22) Filed: May 1, 2023

(51) Int. Cl. A47J 27/00; B65G 33/18

(52) U.S. Cl. CPC A47J 27/002; B65G 33/18; B65G 2201/0202; B65G 2205/00

(57) ABSTRACT

A novel food ingredient dispenser unit (DiU) for an automated-cooking-apparatus is disclosed. Embodiments of the novel DiU may comprise a food-ingredient-cartridge (FIC) and a conveying-screw (CoS). The CoS can be configured to be associated with the FIC and to convey food ingredients from the FIC toward an opening of the DiU. In addition a first end of the CoS is associated with a cork that is configured to block the opening of the DiU when the DiU is not-active. Further, the CoS can be moved in a linear motion in order to open the DiU.

### CROSS-REFERENCE TO RELATED APPLICATION

This is a utility patent application being filed in the United States as a non-provisional application for patent under Title 35 U.S.C. § 100 et seq. and 37 C.F.R. § 1.53(b) and further, this application is related to a utility patent application number U.S. Ser. No. 17/663,895 filed on May 18, 2022, which application is herein incorporated by reference in its entirety.

### FIELD OF THE DISCLOSURE

The present disclosure relates to dispensing of food ingredients in an automated cooking restaurant (ACR).

### BACKGROUND

In order to deliver high quality repeating meals, each dish of the same course has to contain the same food ingredients. Each ingredient has to be in appropriate quantity, temperature, humidity, etc. Usually the required quantity of one ingredient differs from the required quantity of another ingredient. Since an ACR is configured to deliver a plurality of types of courses some of the food ingredients are used more than the other.

Some of the food ingredients are solid, such as but not limited to meat, fish, vegetables, peanuts, beans, etc. Other food ingredients are powder such as but not limited to flour, sugar, salt, etc. Other food ingredients can be fluid such as but not limited to oil, soya, etc. Further, some of the ingredients might be fresh or raw; some might be half cooked or fully cooked, etc.. Other ingredients might be sliced such as but not limited to tomatoes, olives, etc.

Some ACRs are associated with a horizontal-dry-food-dispenser (HDFD). A common HDFD has a plurality of dispensing-units (DiUs). A DiU is capable of handling a single type of food ingredient. The dispensing unit may comprise a food-ingredient-cartridge (FIC) and a conveying-screw (CoS). One end of the CoS is associated with a motor via a quick-disconnecting-mechanism. The other end of the CoS is associated with the opening of the DiU.

The FIC can be placed above the CoS, thus when the CoS turns clockwise (for example) it moves food ingredients from the FIC toward the opening of the DiU and from there the ingredients fall into an ingredient-collecting-vessel, such as but not limited to a pot. The CoS continues to turn until the amount of the collected food ingredients reach the desired weight.

There are cases that when the CoS stops rotating some ingredients may fall into the collecting vessel changing the weight of the relevant ingredient from the required one. There are cases that food ingredients may fall to a collecting-vessel of another dish. Pieces of meat or fish may fall into a pot of a vegetarian dish. Those cases may affect the satisfaction of the customer. In other cases dropping ingredients may pollute the area. Such cases may increase the consumption of the food ingredients and reduces the profitability of the ACR.

### BRIEF SUMMARY

The needs and the deficiencies that are described above are not intended to limit the scope of the inventive concepts of the present disclosure in any manner. The deficiencies are presented for illustration only. The disclosure is directed to a novel DiU. The novel DiU may comprise of a food-ingredient-cartridge (FIC) and a CoS. One end of the CoS can be associated with a motor via a sliding-pair or a prismatic-joint, a rotation-to-linear-movement-converter (RLMC) and a quick-disconnecting-mechanism (QDM). The other end of the CoS, which is near the opening of the DiU, can be associated with a cork. The cork is configured to block the opening of the DiU when it is not active.

In order to deliver food ingredients that reside in a DiU, the CoS starts turning clockwise, for example. A partial turn or the first few turns are converted to linear motion by the RLMC and push the CoS toward the opening of the DiU. Thus the cork that is associated with the CoS is pushed out of the opening of the DiU. The following rotations of the CoS convey food ingredients out of the FIC via the opening of the DiU toward an ingredient-collecting-vessel. The liner movement of the CoS with its rotation is enabled by the sliding-pair. One part of the sliding-pair is associated with the axis of the motor and turns with the rotor of the motor. The other part of the sliding-pair transfers the rotation from the first part while sliding toward the opening of the DiU. Along the disclosure and the claims the verbs “rotate,” “turn,” and “revolve” may be used interchangeably.

When the collected food ingredients reach the required amount the motor start rotating counter clockwise and a spring that is located between the FIC and the quick disconnecting mechanism may push the CoS toward the RLMC, which now pulls the CoS back, away from the opening of the DiU. In other example embodiments the spring can be part of the RLMC. Consequently the cork that is associated with the CoS is pulled back and closes the opening of the DiU. It will be appreciated by persons skilled in the art that the present invention is not limited to the direction of the rotation. Other example embodiment of the disclosed technique may turn counter clockwise in order to deliver food ingredients and rotate clockwise in order to stop delivery of food ingredients.

Some examples of the disclosed technique may use a Helical-Joint in order to convert rotation movement into linear movement. An example of Helical-Joint may comprise a screw and a nut. The nut can be fixed and be associated with the motor while one end of the screw can be associated with the CoS via a QDC while the other end of the screw can be associated with the motor via the sliding-pair. In some example embodiments the screw thread can be dependent on the type of the food ingredient. Other example embodiments may use a pneumatic piston in order to push or pull the CoS.

These and other aspects of the disclosure will be apparent in view of the attached figures and detailed description. The foregoing summary is not intended to summarize each potential embodiment or every aspect of the present invention, and other features and advantages of the present invention will become apparent upon reading the following detailed description of the embodiments with the accompanying drawings and appended claims.

Further, although specific embodiments are described in detail to illustrate the inventive concepts to a person skilled in the art, such embodiments can be modified to various modifications and alternative forms. Accordingly, the figures and written description are not intended to limit the scope of the inventive concepts in any manner.

Other objects, features, and advantages of the present invention will become apparent upon reading the following detailed description of the embodiments with the accompanying drawings and appended claims.

### BRIEF DESCRIPTION OF THE DRAWINGS

Some examples of embodiments of the present disclosure will be understood and appreciated more fully from the following detailed description, taken in conjunction with the drawings in which:

FIG. 1 schematically illustrates an example of DIU in a non-active state;

FIG. 2 schematically illustrates an example of DIU in an active state;

FIG. 3 schematically illustrates second example of DIU in a non-active state;

FIG. 4 schematically illustrates the second example of DIU in an active state;

FIG. 5 illustrates an array of DiUs in which one DiU is active;

FIG. 6 schematically illustrates an example of RLMC located between a motor and a quick-disconnecting-mechanism; and

FIG. 7 schematically illustrates another example of RLMC located between a motor and a quick-disconnecting-mechanism.

### DETAILED DESCRIPTION OF SOME EXAMPLE EMBODIMENTS

Turning now to the figures in which like numerals represent like elements throughout the several views, in which exemplary embodiments of the disclosed techniques are described. For convenience, only some elements of the same group may be labeled with numerals.

The purpose of the drawings is to describe examples of embodiments and not for production purpose. Therefore, features shown in the figures are chosen for convenience and clarity of presentation only. In addition the figures are drawn out of scale. Moreover, the language used in this disclosure has been principally selected for readability and instructional purposes, and may not have been selected to define or limit the inventive subject matter, resort to the claims being necessary to determine such inventive subject matter.

In this specification, these implementations, or any other form that the invention may take, may be referred to as techniques. In general, the order of the steps of disclosed processes may be altered within the scope of the invention. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

In the following description, the words “unit,” “element,” “module”, and “logical module” may be used interchangeably. Anything designated as a unit or module may be a stand-alone unit or a specialized or integrated module. A unit or a module may be modular or have modular aspects allowing it to be easily removed and replaced with another similar unit or module. In addition the terms element and section can be used interchangeably.

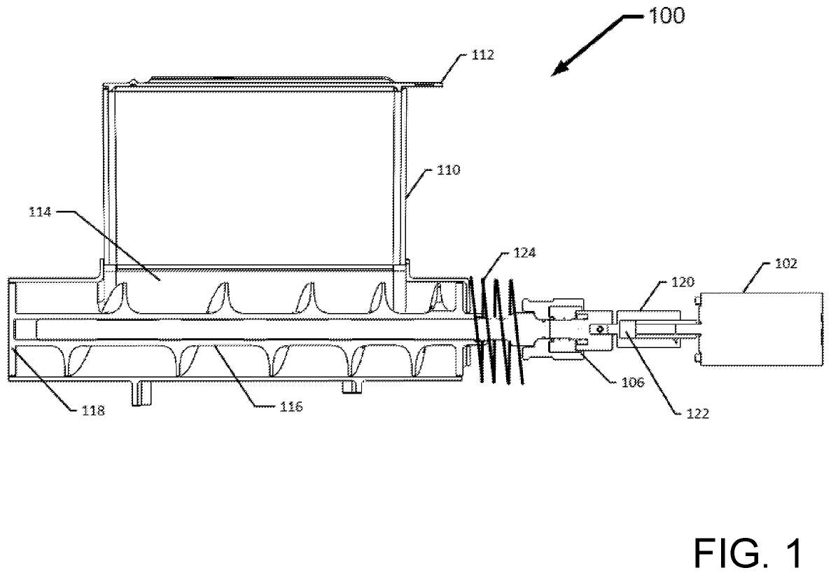

FIG. 1 schematically illustrates an example of DIU 100 in a non-active state. An example of DIU 100 may comprise a food-ingredient-cartridge (FIC) 110 and a CoS 116. The top of the FIC 110 can be closed by cover 112. The bottom 114 of the FIC 110 is open above the CoS 116. Thus, allowing food ingredients that are stored at the FIC 110 to be conveyed by the CoS 116 toward the opening of the DIU 100.

One end of the CoS 116 can be associated with a motor 102 via a sliding-pair or a prismatic-joint 120, a rotation-to-linear-movement-converter (RLMC) 122, a quick-disconnecting-mechanism (QDM) 106 and a spring 124. The other end of the CoS, which is near the opening of the DiU 100, can be associated with a cork 118. The cork is configured to block the opening of the DiU 100 when the DIU is not active.

In a non-active state the spring 124 is in its resting position and the QDM 106, the RLMC 122 and the prismatic-joint 120 are placed close to the motor 102, pulling back the CoS 116 and closing the opening of the DIU 100 by cork 118.

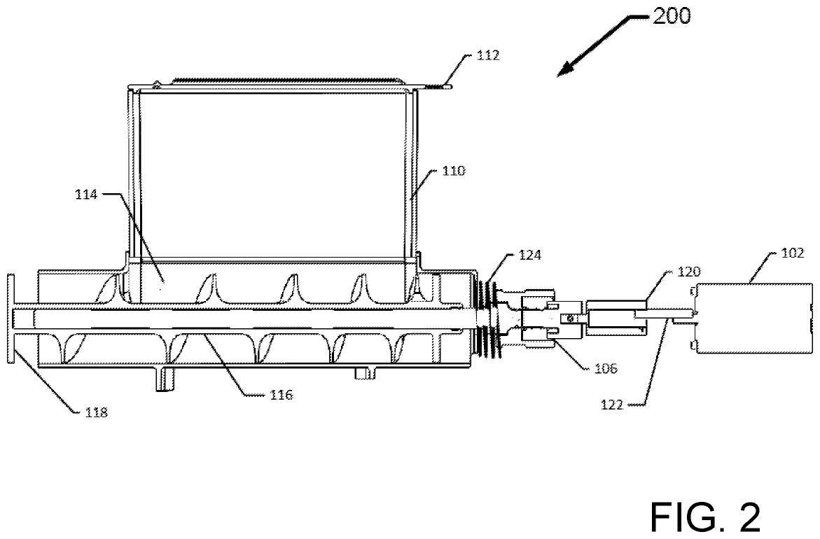

Referring now to FIG. 2, in order to deliver food ingredients that reside in a FIC 110, motor 100 starts rotating the CoS 116 clockwise, for example. A partial turn or the first few turns of the motor can be converted to linear motion by the RLMC 122 pushing the CoS 116 toward the opening of the DiU 100. Thus the cork 118 is pushed out of the opening of the DiU allowing the delivery of the food ingredients that are stored in the FIC 110. The following rotations of the CoS 116 convey food ingredients out of the FIC 110 via the opening 114 of the DiU 100 toward an ingredient-collecting-vessel.

The liner movement of the CoS 116 with its rotation is enabled by the prismatic-joint 120. One part 122 of the prismatic-joint 120 is associated with the axis of the motor and turns with the rotor of the motor. The other part of the prismatic-joint 120 transfers the rotation from the first part while sliding toward the opening of the DiU 200. The liner movement also compresses spring 124 from its resting position, loading the spring 124 with energy that is directed to push back the QDM 106 toward the motor 102.

When the collected food ingredients reach the required amount the motor 102 can be instructed to start rotating counter clockwise and the loaded spring 124 may push the QDM 106 toward the RLMC 120, for engaging the RLMC 120. Thus the engaged RLMC 120 may pull the CoS 116 back, away from the opening of the DiU 200. Consequently the cork 118 that is associated with the CoS 116 is pulled back and closes the opening of the DiU 200. It will be appreciated by persons skilled in the art that the present invention is not limited to the direction of the rotation. Other example embodiment of the disclosed technique may turn counter clockwise in order to deliver food ingredients and rotate clockwise in order to stop delivery of food ingredients and closing the DIU 200.

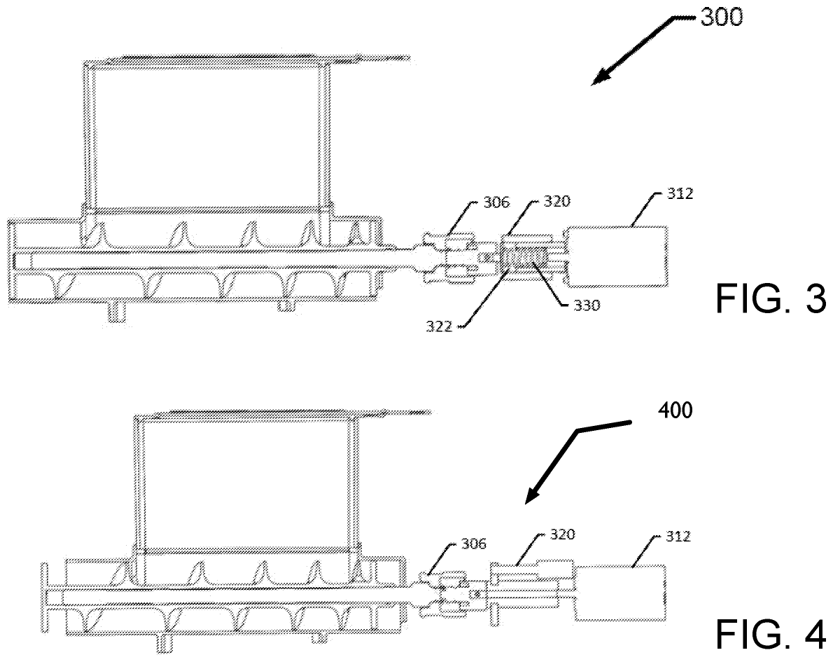

FIG. 3 and FIG. 4 illustrate another example of DIU 300 in which the returning spring 330 is embedded in the prismatic-joint 320. One end of the returning spring 330 is associated with the part of the prismatic-joint 320 that is associated with the motor 312. The other end of the returning spring 330 is associated with the second part of the prismatic-joint 320, which is associated with the QDM 306 via a RLMC 322.

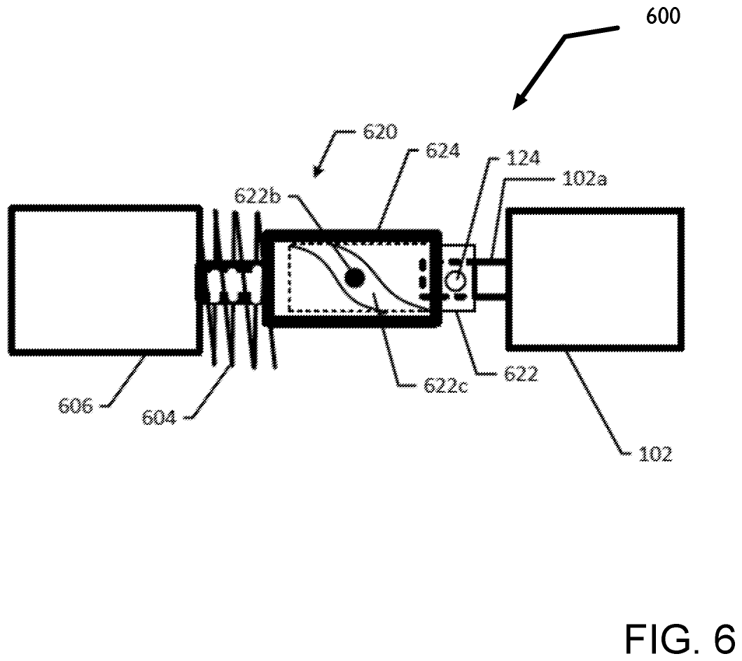

FIG. 3 illustrates the non-active state of the DIU. In this state the QDM 306, the RLMC 322, the prismatic-joint 320 are placed close to the motor 312, pulling back the CoS and closing the opening of the DIU 100. In this state spring 330 is in its resting position. The active position is illustrated in FIG. 4 in which the RLMC 322 pushes the CoS toward the opening of the DiU 100. Thus the cork is pushed out of the opening of the DiU allowing the delivery of the food ingredients that are stored in the FIC. More information about examples of RLMC are disclosed below in conjunction with FIGS. 6 & 7. Along the disclosure and the claims the verbs “rotate,” “turn,” and “revolve” may be used interchangeably.

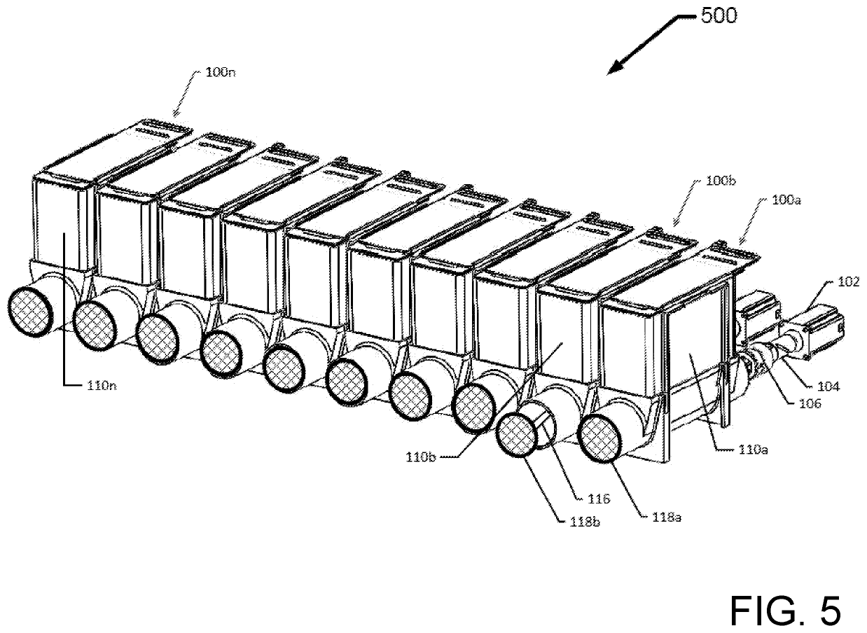

Referring now to FIG. 5 that illustrates an array 500 of DiUs 100a to 100n, in which DiU 100b is active. Each DiU 100a-n may comprise a motor 102 that rotate a CoS 116 via a RLMC 104, a QDM 106 and a FIC 110 and. Some example embodiments of DiU 100a-n may comprise a prismatic-joint (not shown in the figure) between the motor 102 and the RLMC 104.

DiU 100a is currently not active therefore cork 118a closes the opening of DiU 100a. DiU 100b is currently active therefore the RLMC 104 pushes the CoS 116 with cork 118a forward (away from the motor 102) and opens the output of DiU 100b allows the delivery of the food ingredients that are stored in FIC 110b. More information about examples of RLMC 104 are disclosed below in conjunction with FIGS. 6 & 7.

FIG. 6 schematically illustrates an example of RLMC 620 located between a motor 102 and a quick-disconnecting-mechanism (QDM) 606 via spring 604. The axis 102a of the motor 102 can be associated with the CoS via a helical-joint 620 having an internal part 622 and an external part 624. The internal part 622 as well as the external part 624 may have a shape of cylinder. In some example embodiments the external part 624 can slide over the internal part 622. The internal part 622 may have a slot 622c. Slot 622c may be directed toward the edge of the internal cylinder 622. The external part 624 may have a pin 624b that can be associated with the slot 622c. Thus, when the internal part 622 turns clockwise, for example, the movement of the pin 624b along the slot 622c pushes the external part 624 away from the motor 102 compress the spring 604 and pushes the QDM 606 and the CoS (not shown) toward the opening of the relevant DiU for delivering the food ingredients.

When the collected food ingredients reach the required amount the motor 102 may start rotating counter clockwise and the compressed spring 604 may push the external part 624 toward the internal part 622 until the pin 622b be associated with the slot 622c, which now pulls the CoS back, away from the opening of the DiU. It will be appreciated by persons skilled in the art that the present invention is not limited to the direction of the rotation. Other example embodiment of the disclosed technique may turn counter clockwise in order to deliver food ingredients and rotate clockwise in order to stop delivery of food ingredients.

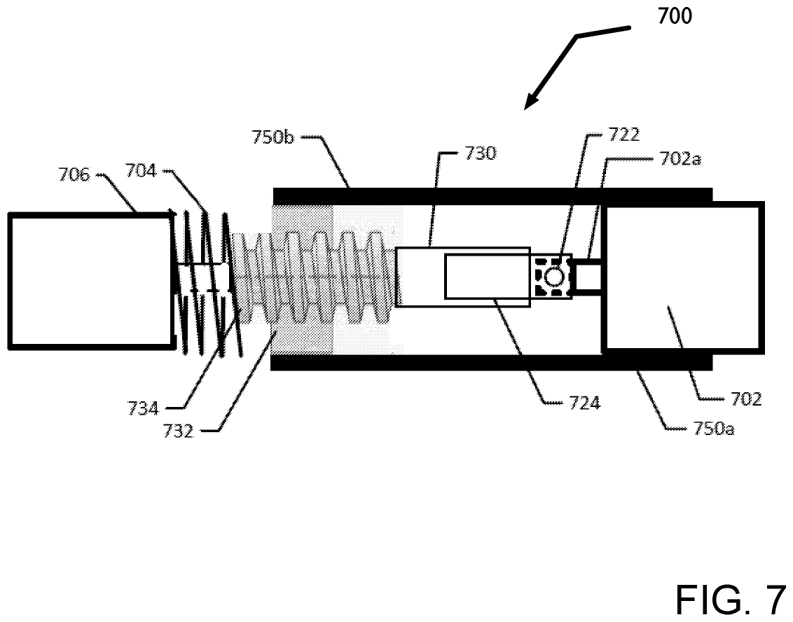

FIG. 7 schematically illustrates an example of RLMC 700 located between a motor 702 and a quick-disconnecting-mechanism (QDM) 706. The example embodiment of RLMC 700 may comprise a motor 702 that turns the CoS (not shown) via QDM 706 and spring 704. The axis 702a of the motor 702 can be associated with the CoS via a prismatic-joint having an internal part 724 and an external part 730. In some example embodiments the external part 730 can slide over the internal part 724. The internal part 724 can be associated with the axis of the motor 702.

The cross section of the prismatic-joint can be a polygon, a square, for example. Thus, when the motor turns the internal part 724 turns too. Due to the polygon cross section of the two parts (724&730) the rotation of the internal part 724 rotates the external part 730 that is associated with a screw 734 of an Helical-Joint. Nut 732 of the Helical-Joint can be associated with the motor 702 via beams 750a&b. Thus, when the motor 702 start turning clockwise the rotation is transferred via the prismatic joint 724&730 to screw 734 that pulls the external part 730 along the internal part 724 in a linear movement and pushing the CoS and the associated cork (not shown) away from the motor 702 and opens of the relevant DiU. In addition the spring 704 is compressed between the QDM 706 and the screw 734.

When the collected food ingredients reach the required amount the motor 702 may start rotating counter clockwise and the compressed spring 704 may push the screw 734 toward the nut 732 until the screw 734 is associated with the nut 732. Consequently, the rotation of screw 734 now pulls the CoS and the associated cork back, toward the motor 702, until opening of the DiU is closed by the cork. It will be appreciated by persons skilled in the art that the present invention is not limited to the direction of the rotation of the screw 734. Other example embodiments of the disclosed technique may turn the screw counter clockwise in order to deliver food ingredients and rotate clockwise in order to stop delivery of food ingredients.

In the description and claims of the present disclosure, each of the verbs, “comprise”, “include”, “have”, and conjugates thereof, are used to indicate that the object or objects of the verb are not necessarily a complete listing of members, components, elements, or parts of the subject or subjects of the verb.

The present disclosure has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Many other ramification and variations are possible within the teaching of the embodiments comprising different combinations of features noted in the described embodiments.

It will be appreciated by persons skilled in the art that the present invention is not limited by what has been particularly shown and described herein above. Rather the scope of the invention is defined by the claims that follow.

1. A food ingredient dispenser unit (DiU) for an automated-cooking-apparatus, comprising:
a food-ingredient-cartridge (FIC); and
a conveying-screw (CoS);
wherein, the CoS is configured to be associated with the FIC and to convey food ingredients from the FIC toward an opening of the DiU; and
wherein a first end of the CoS is associated with a cork that is configured to block the opening of the DiU when the DiU is not-active.

2. The food ingredients DiU of claim 1, wherein a second end of the CoS is associated with a motor via a rotation-to-linear-movement-converter (RLMC).

3. The food ingredients DiU of claim 2, when the DiU be activated, the motor starts turning the CoS in order to convey food ingredients, the beginning of the rotation of the motor is converted to linear movement by the RLMC and pushes the CoS with the cork away from the motor enabling following turns of the CoS to convey food ingredients from the DiU.

4. The food ingredients DiU of claim 3, when the DiU be inactivated, the motor starts turning in the other direction causing the RLMC to pull the CoS with the cork back toward the motor until the cork blocks the opening of the DiU.

5. The food ingredients DiU of claim 2, wherein the RLMC comprises an helical-joint having an internal part and an external part and where in the external part is configured to slid over the internal part.

6. The food ingredients DiU of claim 5, wherein the internal part of the helical-joint is configured to be associated with the axis of the motor.

7. The food ingredients DiU of claim 6, wherein internal part has a slot directed toward its edge and wherein the external part has a pin that penetrates the slot such that when the motor turns the internal part the pin in the slot moves forward in a linear motion pushing the external part away from the motor.

8. The food ingredients DiU of claim 2, wherein the RLMC comprises a prismatic-joint having an internal part and an external part and where in the external part is configured to slid over the internal part.

9. The food ingredients DiU of claim 8, wherein the cross section of the prismatic-joint has a shape of a polygon.

10. The food ingredients DiU of claim 9, wherein the polygon is a square.

11. The food ingredients DiU of claim 8, wherein the RLMC comprises a nut that is fixed in relation to the motor and an appropriate screw that is associated with the external part of the prismatic-joint.

12. The food ingredients DiU of claim 5, further comprising a spring between the second end of the CoS and the RLMC.

13. The food ingredients DiU of claim 12, wherein the spring is configured to push the external part of the helical-joint toward the internal part of the helical-joint when the motor starts turning in the other direction.

14. The food ingredients DiU of claim 8, further comprising a spring between the second end of the CoS and the RLMC.

15. The food ingredients DiU of claim 14, wherein the spring is configured to push the screw of the prismatic-joint toward the nuts of the prismatic-joint when the motor starts turning in the other direction.
